(19) United States
(12) Patent Application Publication
(10) Pub. No.: US 2015/0002637 A1
(43) Pub. Date: Jan. 1, 2015

(54) APPARATUS AND METHOD FOR GENERATING STEREOSCOPIC IMAGE THROUGH INSTALLATION OF EXTERNAL CAMERA

(71) Applicant: ELECTRONICS AND TELECOMMUNICATIONS RESEARCH INSTITUTE, Daejeon (KR)

(72) Inventors: Ho Wook JANG, Daejeon (KR); Hye Sun KIM, Daejeon (KR); Yun Ji BAN, Daejeon (KR); Seung Woo NAM, Daejeon (KR)

(73) Assignee: ELECTRONICS AND TELECOMMUNICATIONS RESEARCH INSTITUTE, Daejeon (KR)

(21) Appl. No.: 14/248,421

(22) Filed: Apr. 9, 2014

(30) Foreign Application Priority Data
Jul. 1, 2013 (KR) 10-2013-0076236

(51) Int. Cl. H04N 13/02

(52) U.S. Cl. CPC H04N 13/0239
USPC 348/47

(57) ABSTRACT

Provided is an apparatus and method for generating a stereoscopic image through installation of an external camera, the apparatus including a characteristic comparator to compare a characteristic of an internal camera module and a characteristic of the external camera module, a matching performer to perform an image characteristic matching process on the internal camera module and the external camera module when a comparison result indicates a presence of a difference in characteristics of the internal camera module and the external camera module, an image acquirer to acquire a plurality of images of an object using the internal camera module and the external camera module on which the image characteristic matching process is performed, and a stereoscopic image generator to generate a stereoscopic image by integrating the plurality of images.

### CROSS-REFERENCE TO RELATED APPLICATION

This application claims the priority benefit of Korean Patent Application No. 10-2013-0076236, filed on Jul. 1, 2013, in the Korean Intellectual Property Office, the disclosure of which is incorporated herein by reference.

### BACKGROUND

1. Field of the Invention

The present invention relates to a technology for performing a characteristic matching process in conjunction with installation of an external camera module having a characteristic different from a characteristic of an internal camera module, and acquiring a plurality of images of an object using the internal camera module and the external camera module to integrate the plurality of images, thereby generating a stereoscopic image.

2. Description of the Related Art

In order to capture a stereoscopic image, technology for acquiring a left image and a right image of an object by a terminal including two identical cameras has been developed.

Since the terminal includes two camera lenses, a size and a weight of the terminal may increase and a price of the terminal may be higher than a price of a terminal using two cameras. Also, when use of the terminal is preferred for a two-dimensional (2D) image rather than a stereoscopic image, an issue of wasted resources may result.

Accordingly, there is a desire for technology to be used for installing an external camera module in a terminal including an internal camera module, as needed, and matching a characteristic of the internal camera module and a characteristic of the external camera module when a difference in the characteristics is present, thereby generating a stereoscopic image.

### SUMMARY

An aspect of the present invention provides an apparatus and method for generating a stereoscopic image by acquiring a left image and a right image of an object using an internal camera module and an external camera module.

Another aspect of the present invention also provides an apparatus and method for matching a characteristic of an internal camera module and a characteristic of an external camera module when a difference in the characteristics is present.

According to an aspect of the present invention, there is provided an apparatus for generating a stereoscopic image, the apparatus including a characteristic comparator to compare a characteristic of an internal camera module and a characteristic of an external camera module, a matching performer to perform an image characteristic matching process on the internal camera module and the external camera module when a result of the comparing indicates a presence of a difference in characteristics of the internal camera module and the external camera module, an image acquirer to acquire a plurality of images of an object using the internal camera module and the external camera module on which the image characteristic matching process is performed, and a stereoscopic image generator to generate a stereoscopic image by integrating the plurality of images.

According to another aspect of the present invention, there is also provided a method of generating a stereoscopic image, the method including comparing, in conjunction with installation of an external camera module, a characteristic of an internal camera module and a characteristic of the external camera module, performing an image characteristic matching process on the internal camera module and the external camera module when a result of the comparing indicates a presence of a difference in characteristics of the internal camera module and the external camera module, acquiring a plurality of images of an object using the internal camera module and the external camera module on which the image characteristic matching process is performed, and generating a stereoscopic image by integrating the plurality of images.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of an apparatus for generating a stereoscopic image according to an embodiment of the present invention;

FIG. 2 is a diagram illustrating an example of performing an image characteristic matching process according to an embodiment of the present invention;

FIG. 3 is a flowchart illustrating an example of eliminating an inconsistency factor according to an embodiment of the present invention; and

FIG. 4 is a flowchart illustrating a method of generating a stereoscopic image according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

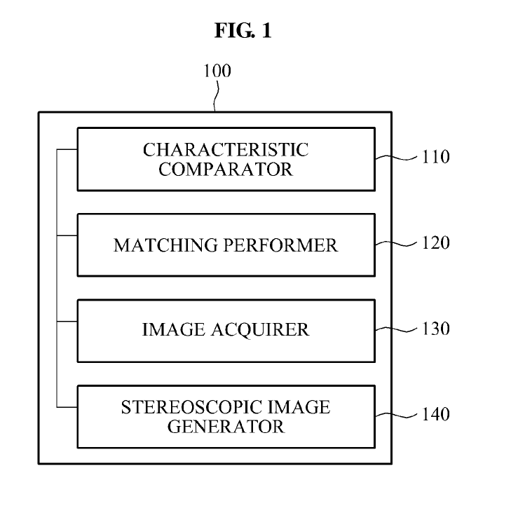

FIG. 1 is a diagram illustrating a configuration of an apparatus for generating a stereoscopic image according to an embodiment of the present invention.

Referring to FIG. 1, an apparatus 100 for generating a stereoscopic image may include a characteristic comparator 110, a matching performer 120, an image acquirer 130, and a stereoscopic image generator 140.

The characteristic comparator 110 may compare a characteristic of an internal camera module and a characteristic of an external camera module in conjunction with installation of the external camera module. The external camera module and the internal camera module may be disposed at a predetermined distance to capture an identical object. For example, when the external camera module and the internal camera module are disposed to be separated by a horizontal distance of four centimeters (cm), and capture an object, a left image and a right image, images capturing the object at different locations may be acquired. The internal camera module may be included in the apparatus 100 for generating a stereoscopic image and used to capture an image or a video in a fixed state. In contrast, the external camera module may be attached to and detached from the apparatus 100 for generating a stereoscopic image with a communication interface that may be connected to an external area of the apparatus 100 for generating a stereoscopic image. Also, the external camera module may be substituted to another external camera module having another characteristic.

The characteristic comparator 110 may analyze the two images acquired by the internal camera module and the external camera module and compare characteristics of the two images.

When a difference in the characteristics of the two images is present, the matching performer 120 may perform an image characteristic matching process on the internal camera module and the external camera module. The difference may vary based on a type of lens included in each of the internal camera module and the external camera module.

The matching performer 120 may compare a view angle of the internal camera module and a view angle of the external camera module. The view angle may refer to a visual range of an image captured when the internal camera module and the external camera module detect the object through lenses.

The matching performer 120 may match a first view angle at which the internal camera module faces the object and a second view angle at which the external camera module faces the object. When the first view angle is greater than the second view angle, the first view angle may capture a wide background around the object when compared to the second view angle such that the object may look relatively small. The matching performer 120 may adjust the first view angle by decreasing a size of the first view angle by a size of the second view angle. Here, adjusting the size of the first view angle to be decreased by the size of the second view angle may be performed through software.

In another example embodiment, the matching performer 120 may adjust the second view angle by increasing the size of the second view angle by the size of the first view angle. In this example, adjusting the size of the second view angle to be increased by the size of the second view angle may be performed through a manual user operation, for example, a zoom adjustment of a lens, because performing an adjustment through software may be unavailable.

The matching performer 120 may analyze temporary images of the object captured using the internal camera module and the external camera module to compare resolutions of the temporary images. A temporary image may include a number of pixels varying based on a resolution level. When a resolution of the internal camera module is greater than a resolution of the external camera module, the object may look relatively clear in a temporary image of the internal camera module as compared to a temporary image of the external camera module. In addition, as the resolution of the internal camera module increases, a greater number of pixels may be stored in the temporary image to express a precision of the object.

The matching performer 120 may match a first resolution of the temporary image captured by the internal camera module and a second resolution of the temporary image captured by the external camera module. For example, when the first resolution is greater than the second resolution, the matching performer 120 may perform resolution adjustment by decreasing a number of pixels.

As another example, when the first resolution is less than the second resolution, the matching performer 120 may perform the resolution adjustment by increasing a number of pixels. For example, when the first resolution is less than the second resolution, the matching performer 120 may perform a process of increasing the first resolution to a level of a second resolution, which may cause degradation in image quality. In an embodiment of the present invention, a degree of the degradation in image quality may be minimized by applying lossless super-resolution technology.

The matching performer 120 may eliminate an inconsistency factor resulting from a difference in performances of the internal camera module and the external camera module.

The matching performer 120 may compare a first location of the object included in the temporary image captured by the internal camera module and a second location of the object included in the temporary image captured by the external camera module, and may determine whether the second location matches the first location, after the image characteristic matching process is performed.

The matching performer 120 may match the second location to the first location by vertically or horizontally adjusting the second location in the temporary image based on the first location, thereby eliminating the inconsistency factor. The matching performer 120 may horizontally adjust the first location and the second location such that a predetermined degree of parallax is maintained with respect to the object.

The matching performer 120 may match a first color of the temporary image captured by the internal camera module and a second color of the temporary image captured by the external camera module to eliminate the inconsistency factor.

In this specification, for convenience and ease of description, an operation of acquiring an image is explained to be implemented after an operation of the image characteristic matching process is performed. However, one skilled in the art may readily understand that the operation of acquiring an image and the operation of the image characteristic matching process may be implemented simultaneously, depending on an embodiment.

The image acquirer 130 may acquire a plurality of images of the object using the internal camera module and the external camera module on which the image characteristic matching process is performed. When the internal camera module and the external camera module are disposed on a left side and a right side relative to the object, the plurality of images may include a left image and a right image of the object to which the disposed internal camera module and the disposed external camera module face.

The image acquirer 130 may adjust a distance between the internal camera module and the external camera module. In a stereoscopic image in which the plurality of images is integrated, a degree of depth perception of the object may be determined based on the distance.

The stereoscopic image generator 140 may generate the stereoscopic image by integrating the plurality of images. The stereoscopic image generator 140 may match two corresponding pixel values in the plurality of images having the same resolutions, thereby generating the stereoscopic image in which a portion of the object overlaps.

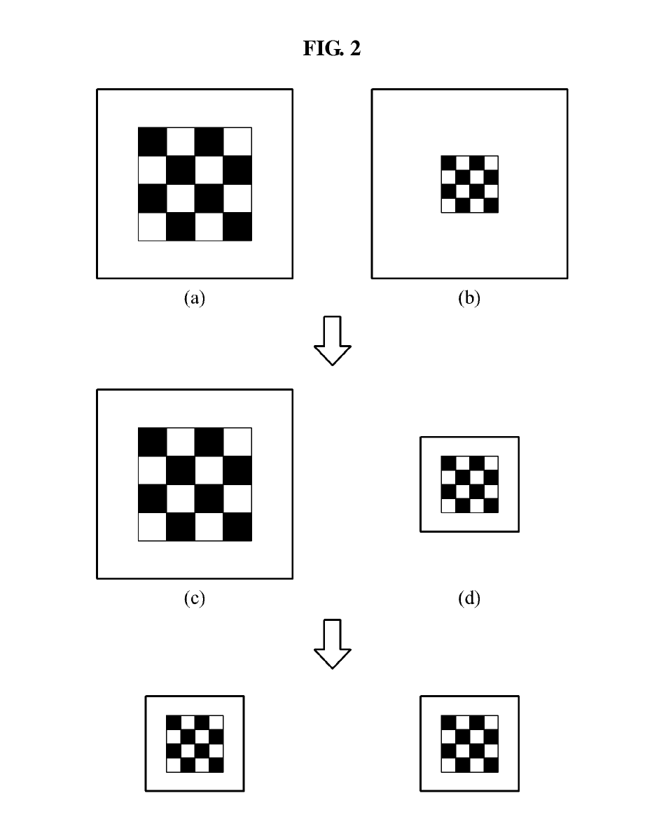

FIG. 2 is a diagram illustrating an example of performing an image characteristic matching process according to an embodiment of the present invention.

Referring to FIG. 2, an apparatus for generating a stereoscopic image may analyze a temporary image (a) captured by an internal camera module and a temporary image (b) captured by an external camera module, and compare a characteristic of the internal camera module and a characteristic of the external camera module.

The apparatus for generating a stereoscopic image may compare a view angle, which is one of the characteristics of the internal camera module, and a view angle of the external camera module, based on a size of an object included in the temporary image (a) and the temporary image (b). The internal camera module and the external camera module may be disposed horizontally and operated at identical distances from the object. Also, a ratio of the object may vary in an overall image based on the view angle.

The ratio of the object in the temporary image (a) may be greater than the ratio of the object in the temporary image (b). Thus, the apparatus for generating a stereoscopic image may verify that a first view angle of the internal camera module is less than a second view angle of the external camera module. Depending on a case, the apparatus for generating a stereoscopic image may verify that the second view angle of the external camera module is less than the first view angle of the internal camera module.

The apparatus for generating a stereoscopic image may generate a temporary image (c) and a temporary image (d) as a result of downsizing the second view angle while maintaining a size of the first view angle.

The apparatus for generating a stereoscopic image may calculate a size of the temporary image (c) and a size of the temporary image (d), and compare a resolution of the internal camera module and a resolution of the external camera module, thereby verifying a difference in characteristics.

The size of the temporary image (c) and the size of the temporary image (d) may vary based on a number of pixels. When a number of pixels included in the temporary image (c) is greater than a number of pixels included in the temporary image (d), the apparatus for generating a stereoscopic image may verify that a first resolution of the internal camera module is greater than a second resolution of the external camera module. As another example, the apparatus for generating a stereoscopic image may verify that the first resolution of the internal camera module is less than the second resolution of the external camera module.

The apparatus for generating a stereoscopic image may match a first resolution of a temporary image of an object captured by the internal camera module and a second resolution of a temporary image of an object captured by the external camera module. To this end, the apparatus for generating a stereoscopic image may adjust the second resolution, which is relatively high, by reducing the number of pixels.

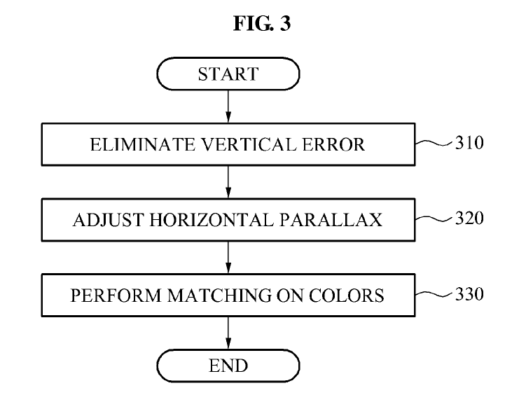

FIG. 3 is a flowchart illustrating an example of eliminating an inconsistency factor according to an embodiment of the present invention.

An apparatus for generating a stereoscopic image may compare a characteristic of an internal camera module and a characteristic of an external camera module, and perform a matching process on view angles and resolutions of the internal camera module and the external camera module, thereby eliminating the inconsistency factor resulting from a difference in performances.

Referring to FIG. 3, in operation 310, the apparatus for generating a stereoscopic image may eliminate a vertical error by vertically adjusting a second location of an object included in a temporary image captured by the external camera module, based on a first location of the object in a temporary image captured by the internal camera module. When an image of the object is generated, a location of the object may vary vertically based on an incline angle of the apparatus for generating a stereoscopic image, a location of the internal camera module, and a location of the external camera module. The apparatus for generating a stereoscopic image may eliminate a side effect, for example, dizziness which a user may experience due to the vertical error by adjusting the first location and the second location.

In operation 320, the apparatus for generating a stereoscopic image may adjust a degree of horizontal parallax by adjusting the second location based on the first location. A horizontal difference between the first location and the second location may form an occurrence of parallax. The apparatus for generating a stereoscopic image may adjust the second location to be located in a right direction based on the first location. When a stereoscopic image is generated, the object of the internal camera module may be recognized through a left eye, and the object of the external camera module may be recognized through a right eye. Depending on a case, the object of the internal camera module may be recognized through the right eye, and the object of the external camera module may be recognized through the left eye.

In this instance, when the first location differs horizontally from the second location, an effect similar to extracting the object from an image may occur.

In operation 330, the apparatus for generating a stereoscopic image may match a first color of the temporary image captured by the internal camera module and a second color of the temporary image captured by the external camera module to eliminate the inconsistency factor.

The internal camera module and the external camera module may include a sensor to receive light and convert the light into an electronic signal. Inconsistency in colors may be caused by a process in which the sensor separates various lights based on wavelengths.

The apparatus for generating a stereoscopic image may match a pixel value of the temporary image captured by the internal camera module and a pixel value of the temporary image captured by the external camera module. The apparatus for generating a stereoscopic image may match the first color and the second color by analyzing a degree of correlation among differences of the pixel values or operating the pixels values with a predetermined reference value.

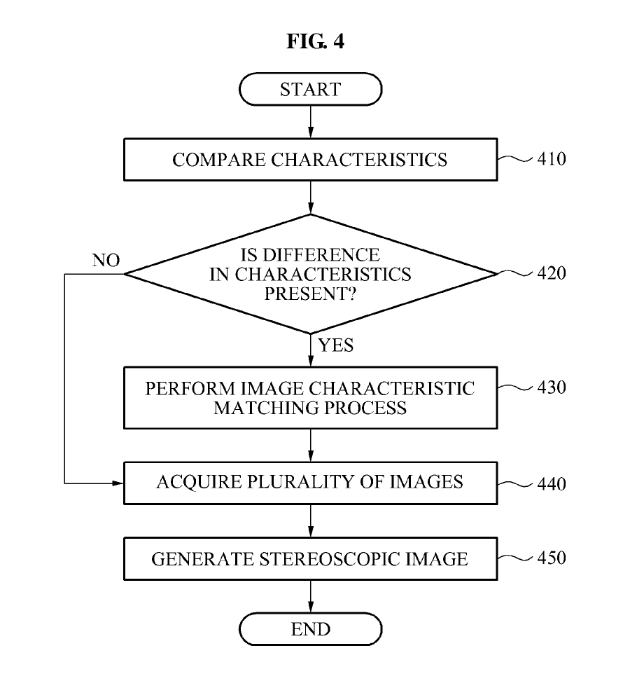

FIG. 4 is a flowchart illustrating a method of generating a stereoscopic image according to an embodiment of the present invention.

Referring to FIG. 4, in operation 410, an apparatus for generating a stereoscopic image may compare a characteristic of an internal camera module and a characteristic of an external camera module in conjunction with installation of the external camera module. The external camera module and the internal camera module may be disposed at a predetermined distance to capture an identical object.

In operation 420, the apparatus for generating a stereoscopic image may analyze images acquired by the internal camera module and the external camera module, and determine whether a difference in the characteristics is present.

In operation 430, when the difference in the characteristics is present, the apparatus for generating a stereoscopic image may perform an image characteristic matching process on the internal camera module and the external camera module. The characteristics may vary based on a difference between lenses of the internal camera module and the external camera module.

Among the characteristics, the apparatus for generating a stereoscopic image may compare a first view angle at which the internal camera module faces the object and a second view angle at which the external camera faces the object, and match the first view angle and the second view angle. The apparatus for generating a stereoscopic image may adjust a size of the first view angle to be decreased by a size of the second view angle.

The apparatus for generating a stereoscopic image may compare a first resolution of a temporary image of the object captured by the internal camera module and a second resolution of a temporary image of the object captured by the external camera module, and may match the first resolution and the second resolution.

The apparatus for generating a stereoscopic image may eliminate an inconsistency factor resulting from a difference in performances of the internal camera module and the external camera module after the image characteristic matching process is performed.

The apparatus for generating a stereoscopic image may match the second location to the first location by vertically or horizontally adjusting the second location in the temporary image based on the first location.

The apparatus for generating a stereoscopic image may eliminate the inconsistency factor by matching a first color of a temporary image captured by the internal camera module and a second color of a temporary image captured by the external camera module.

In operation 440, the apparatus for generating a stereoscopic image may acquire a plurality of images of the object using the internal camera module and the external camera module on which the image characteristic matching process is performed. When the internal camera module and the external camera module are disposed on a left side and a right side relative to the object, the plurality of images may include a left image and a right image of the object to which the internal camera module and the external camera module face.

The apparatus for generating a stereoscopic image may adjust a distance between the internal camera module and the external camera module.

In operation 450, the apparatus for generating a stereoscopic image may generate a stereoscopic image by integrating the plurality of images. The stereoscopic image generator 140 of FIG. 1 may match two corresponding pixel in the plurality of images having identical resolutions, thereby generating the stereoscopic image in which a portion of the object overlaps.

According to an aspect of the present invention, it is possible to selectively capture a two-dimensional (2D) image and a stereoscopic image by recognizing installation of an external camera module.

According to another aspect of the present invention, it is also possible to utilize various external camera modules by matching a characteristic of an internal camera module and a characteristic of an external camera module when a difference in the characteristic is present.

The method according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy discs, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An apparatus for generating a stereoscopic image, the apparatus comprising:
a characteristic comparator to compare, in conjunction with installation of an external camera module, a characteristic of an internal camera module and a characteristic of the external camera module;
a matching performer to perform an image characteristic matching process on the internal camera module and the external camera module when a result of the comparing indicates a presence of a difference in characteristics of the internal camera module and the external camera module;
an image acquirer to acquire a plurality of images of an object using the internal camera module and the external camera module on which the image characteristic matching process is performed; and
a stereoscopic image generator to generate a stereoscopic image by integrating the plurality of images.

2. The apparatus of claim 1, wherein the matching performer matches a first view angle at which the internal camera module faces the object and a second view angle at which the external camera module faces the object.

3. The apparatus of claim 1, wherein the matching performer matches a first resolution of a temporary image of the object captured by the internal camera module and a second resolution of a temporary image of the object captured by the external camera module.

4. The apparatus of claim 1, wherein the matching performer eliminates an inconsistency factor resulting from a difference in performances of the internal camera module and the external camera module.

5. The apparatus of claim 4, wherein the matching performer eliminates the inconsistency factor by matching a first location of the object included in a temporary image captured by the internal camera module and a second location of the object included in a temporary image captured by the external camera module.

6. The apparatus of claim 5, wherein the matching performer matches the second location to the first location by vertically or horizontally adjusting the second location in the temporary image based on the first location.

7. The apparatus of claim 4, wherein the matching performer eliminates the inconsistency factor by matching a first color of a temporary image captured by the internal camera module and a second color of a temporary image captured by the external camera module.

8. The apparatus of claim 4, wherein the matching performer eliminates the inconsistency factor after performing the image characteristic matching process.

9. The apparatus of claim 1, wherein the image acquirer acquires a left image and a right image of the object captured by the internal camera module and the external camera module, respectively.

10. The apparatus of claim 1, wherein the image acquirer acquires a plurality of images of the object by adjusting a distance between the internal camera module and the external camera module.

11. A method of generating a stereoscopic image, the method comprising:
comparing, in conjunction with installation of an external camera module, a characteristic of an internal camera module and a characteristic of the external camera module;
performing an image characteristic matching process on the internal camera module and the external camera module when a result of the comparing indicates a presence of a difference in characteristics of the internal camera module and the external camera module;
acquiring a plurality of images of an object using the internal camera module and the external camera module on which the image characteristic matching process is performed; and
generating a stereoscopic image by integrating the plurality of images.

12. The method of claim 11, wherein the performing comprises matching a first view angle at which the internal camera module faces the object and a second view angle at which the external camera module faces the object.

13. The method of claim 11, wherein the performing comprises matching a first resolution of a temporary image of the object captured by the internal camera module and a second resolution of a temporary image of the object captured by the external camera module.

14. The method of claim 11, further comprising:
eliminating, irrespective of a result of the comparing, an inconsistency factor resulting from a difference in performances of the internal camera module and the external camera module.

15. The method of claim 14, wherein the eliminating comprises matching a first location of the object included in a temporary image captured by the internal camera module and a second location of the object included in a temporary image captured by the external camera module.

16. The method of claim 15, wherein the matching comprises vertically or horizontally adjusting the second location in the temporary image based on the first location.

17. The method of claim 14, wherein the eliminating comprises matching a first color of a temporary image captured by the internal camera module and a second color of a temporary image captured by the external camera module.

18. The method of claim 14, wherein the eliminating is initiated after the image characteristic matching process is terminated.

19. The method of claim 11, wherein the acquiring comprises acquiring a left image and a right image of the object captured by the internal camera module and the external camera module, respectively.

20. The method of claim 11, wherein the acquiring comprises acquiring a plurality of images of the object by adjusting a space between the internal camera module and the external camera module.
